(19) United States
(12) Patent Application Publication
(10) Pub. No.: US 2017/0208153 A1
(43) Pub. Date: Jul. 20, 2017

(54) WIRELESS DEVICE, METHOD, AND COMPUTER READABLE MEDIA FOR A HIGH EFFICIENCY SIGNAL-A FIELD IN A HIGH EFFICIENCY WIRELESS LOCAL-AREA NETWORK

(71) Applicant: Intel IP Corporation, Santa Clara, CA (US)

(72) Inventors: Qinghua Li, San Ramon, CA (US); Xiaogang Chen, Hillsboro, OR (US); Po-Kai Huang, West Lafayette, IN (US); Rongzhen Yang, Shanghai (CN); Peng Meng, Shanghai (CN)

(21) Appl. No.: 15/324,033

(22) PCT Filed: Jun. 26, 2015
(86) PCT No.: PCT/US2015/038040

§ 371 Date: Jan. 5, 2017

Related U.S. Application Data
(60) Provisional application No. 62/032,954, filed on Aug. 4, 2014.
(60) Provisional application No. 62/064,353, filed on Oct. 15, 2014.
(60) Provisional application No. 62/111,502, filed on Feb. 3, 2015.

(51) Int. Cl. H04L 29/06; H04L 27/26

(52) U.S. Cl. CPC H04L 69/22; H04L 27/2607; H04L 27/2602; H04W 84/12

(57) ABSTRACT

Wireless devices, methods, and computer readable media for a high efficiency (HE) signal-A field are disclosed. An apparatus of a HE wireless local area network (HEW) station is disclosed. The apparatus of the HEW station includes circuitry configured to: generate a HE preamble comprising a legacy signal (L-SIG) field followed by a HE-SIG-A1 field, wherein the HE-SIG-A1 field is encoded individually. The circuitry may be further configured to transmit the HE preamble on at least one from the following group: multiple subcarriers of a sub-channel and multiple sub-channels. The circuitry may be configured to transmit the HE preamble with a cyclic prefix (CP) of the HE-SIG-A field that is longer than 0.8 micro-seconds (μs). The circuitry may be configured to indicate enhanced robustness of the packet in a length field of the L-SIG field, a polarization of a repeated L-SIG, and/or a field of the HE-SIG-A.

### PRIORITY CLAIM

This application claims the benefit of priority to U.S. Provisional Patent Application Ser. No. 62/111,502, filed Feb. 3, 2015, U.S. Provisional Patent Application Ser. No. 62/032,954, filed Aug. 4, 2014, and U.S. Provisional Patent Application Ser. No. 62/064,353, filed Oct. 15, 2014, all of which are incorporated herein by reference in their entirety.

### TECHNICAL FIELD

Embodiments pertain to wireless networks. Some embodiments relate to transmitting and receiving packets in wireless local area networks (WLANs) including networks operating in accordance with the Institute of Electronic and Electrical Engineers (IEEE) 802.11 family of standards. Some embodiments relate to IEEE 802.11ax. Some embodiments relate to indicating the protocol version of a packet. Some embodiments relate to indicating the protocol version of a packet is IEEE 802.11ax. Some embodiments relate to encoding a high-efficiency signal A (HE-SIG-A) field to indicate the protocol of the packet. Some embodiments relate to enhancements to improve reliability of transmitting HE-SIG preambles.

### BACKGROUND

One issue in wireless local area networks (WLANs) is efficiently using the wireless medium. Additionally, the wireless network may support different protocols including legacy protocols.

Thus, there are general needs for systems and methods for efficiently using the wireless medium, and in particularly, to efficiently indicate the protocol version of a packet.

### BRIEF DESCRIPTION OF THE DRAWINGS

The present disclosure is illustrated by way of example and not limitation in the figures of the accompanying drawings, in which like references indicate similar elements and in which:

FIG. 1 illustrates a WLAN in accordance with some embodiments;

FIG. 2 illustrates a preamble for IEEE 802.11ax in accordance with some embodiments;

FIG. 3 illustrates a preamble for IEEE 802.11ax in accordance with some embodiments;

FIG. 4 illustrates a preamble for IEEE 802.11ax in accordance with some embodiments;

FIG. 5 illustrates the frequency domain repetition of a HE-SIG-A1 in accordance with some embodiments;

FIG. 6 illustrates a transmitter method for repeating the HE-SIG-A1 in accordance with some embodiments;

FIG. 7 illustrates a packet with a partially masked cyclic redundancy code in accordance with some embodiments;

FIG. 8 illustrates the packet error rates (PERs) for a baseline and frequency repetition in accordance with some embodiments;

FIG. 9 illustrates a method for transmitting a packet with an IEEE 802.11ax preamble in accordance with some embodiments;

FIG. 10 illustrates a method for determining a packet is an IEEE 802.11ax packet in accordance with some embodiments; and

FIG. 11 illustrates a HEW device in accordance with some embodiments.

### DETAILED DESCRIPTION

The following description and the drawings sufficiently illustrate specific embodiments to enable those skilled in the art to practice them. Other embodiments may incorporate structural, logical, electrical, process, and other changes. Portions and features of some embodiments may be included in, or substituted for, those of other embodiments. Embodiments set forth in the claims encompass all available equivalents of those claims.

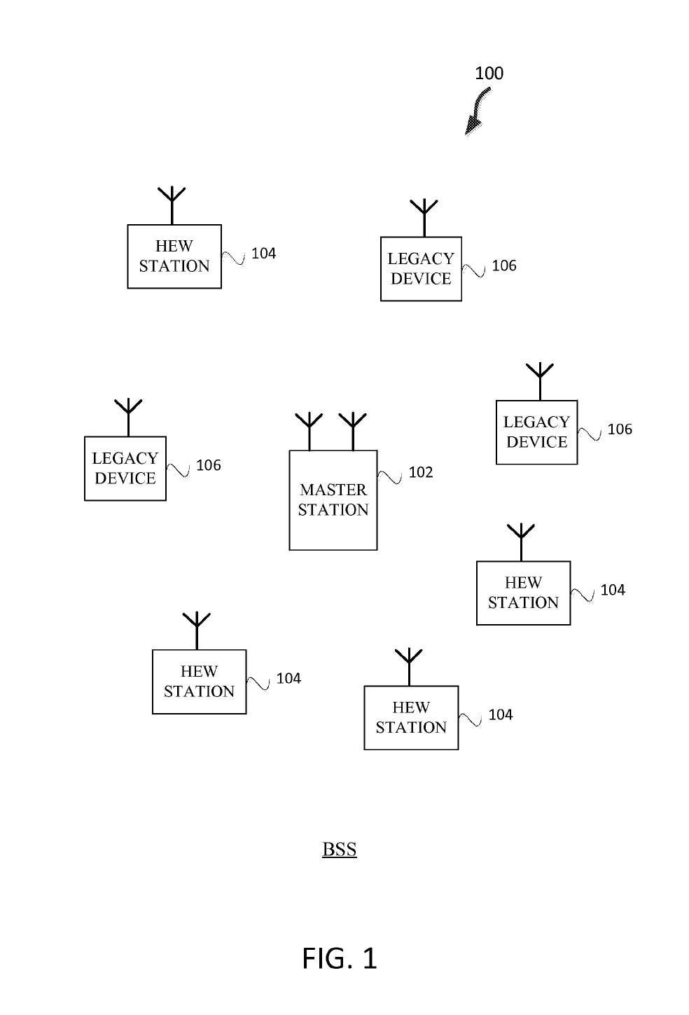

FIG. 1 illustrates a WLAN 100 in accordance with some embodiments. The WLAN may comprise a basis service set (BSS) 100 that may include a master station 102, which may be an AP, a plurality of high-efficiency wireless (HEW) (e.g., IEEE 802.11ax) STAs 104 and a plurality of legacy (e.g., IEEE 802.11n/ac) devices 106.

The master station 102 may be an AP using the IEEE 802.11 to transmit and receive. The master station 102 may be a base station. The master station 102 may use other communications protocols as well as the IEEE 802.11 protocol. The IEEE 802.11 protocol may be IEEE 802.11ax. The IEEE 802.11 protocol may include using OFDMA, time division multiple access (TDMA), and/or code division multiple access (CDMA). The IEEE 802.11 protocol may include a multiple access technique. For example, the IEEE 802.11 protocol may include space-division multiple access (SDMA) and/or MU-MIMO.

The legacy devices 106 may operate in accordance with one or more of IEEE 802.11 a/g/ag/n/ac, or another legacy wireless communication standard. The legacy devices 106 may be STAs or IEEE STAs.

The HEW STAs 104 may be wireless transmit and receive devices such as cellular telephone, handheld wireless device, wireless glasses, wireless watch, wireless personal device, tablet, or another device that may be transmitting and receiving using the IEEE 802.11 protocol such as IEEE 802.11ax or another wireless protocol. In some embodiments, the HEW STAs 104 may be termed high efficiency (HE) stations.

The BSS 100 may operate on a primary channel and one or more secondary channels or sub-channels. The BSS 100 may include one or more master stations 102. In accordance with some embodiments, the master station 102 may communicate with one or more of the HEW devices 104 on one or more of the secondary channels or sub-channels or the primary channel. In accordance with some embodiments, the master station 102 communicates with the legacy devices 106 on the primary channel. In accordance with some embodiments, the master station 102 may be configured to communicate concurrently with one or more of the HEW STAs 104 on one or more of the secondary channels and a legacy device 106 utilizing only the primary channel and not utilizing any of the secondary channels.

The master station 102 may communicate with legacy devices 106 in accordance with legacy IEEE 802.11 communication techniques. In example embodiments, the master station 102 may also be configured to communicate with HEW STAs 104 in accordance with legacy IEEE 802.11 communication techniques. Legacy IEEE 802.11 communication techniques may refer to any IEEE 802.11 communication technique prior to IEEE 802.11ax.

In some embodiments, a HEW frame may be configurable to have the same bandwidth as a sub-channel, and the bandwidth may be one of 20 MHz, 40 MHz, or 80 MHz, 160 MHz, 320 MHz contiguous bandwidths or an 80+80 MHz (160 MHz) non-contiguous bandwidth. In some embodiments, bandwidths of 1 MHz, 1.25 MHz, 2.0 MHz, 2.5 MHz, 5 MHz and 10 MHz, or a combination thereof or another bandwidth that is less or equal to the available bandwidth, may also be used. A HEW frame may be configured for transmitting a number of spatial streams, which may be in accordance with MU-MIMO.

In other embodiments, the master station 102, HEW STA 104, and/or legacy device 106 may also implement different technologies such as code division multiple access (CDMA) 2000, CDMA 2000 1×, CDMA 2000 Evolution-Data Optimized (EV-DO), Interim Standard 2000 (IS-2000), Interim Standard 95 (IS-95), Interim Standard 856 (IS-856), Long Term Evolution (LTE), Global System for Mobile communications (GSM), Enhanced Data rates for GSM Evolution (EDGE), GSM EDGE (GERAN), IEEE 802.16 (i.e., Worldwide Interoperability for Microwave Access (WiMAX)), BlueTooth®, or other technologies.

Some embodiments relate to HEW communications. In accordance with some IEEE 802.11ax embodiments, a master station 102 may operate as a master station which may be arranged to contend for a wireless medium (e.g., during a contention period) to receive exclusive control of the medium for an HEW control period. In some embodiments, the HEW control period may be termed a transmission opportunity (TXOP). The master station 102 may transmit a HEW master-sync transmission, which may be a trigger frame or HEW control and schedule transmission, at the beginning of the HEW control period. The master station 102 may transmit a time duration of the TXOP and sub-channel information. During the HEW control period, HEW STAs 104 may communicate with the master station 102 in accordance with a non-contention based multiple access technique such as OFDMA or MU-MIMO. This is unlike conventional WLAN communications in which devices communicate in accordance with a contention-based communication technique, rather than a multiple access technique. During the HEW control period, the master station 102 may communicate with HEW stations 104 using one or more HEW frames. During the HEW control period, the HEW STAs 104 may operate on a sub-channel smaller than the operating range of the master station 102. During the HEW control period, legacy stations refrain from communicating. In accordance with some embodiments, during the master-sync transmission the HEW STAs 104 may contend for the wireless medium with the legacy devices 106 being excluded from contending for the wireless medium during the master-sync transmission.

In some embodiments, the multiple-access technique used during the HEW control period may be a scheduled OFDMA technique, although this is not a requirement. In some embodiments, the multiple access technique may be a time-division multiple access (TDMA) technique or a frequency division multiple access (FDMA) technique. In some embodiments, the multiple access technique may be a space-division multiple access (SDMA) technique.

The master station 102 may also communicate with legacy stations 106 and/or HEW stations 104 in accordance with legacy IEEE 802.11 communication techniques. In some embodiments, the master station 102 may also be configurable to communicate with HEW stations 104 outside the HEW control period in accordance with legacy IEEE 802.11 communication techniques, although this is not a requirement.

In example embodiments, the HEW device and/or the master station 102 are configured to perform the methods and functions described in conjunction with FIGS. 1-11.

Some embodiments relate to high-efficiency wireless communications including high-efficiency Wi-Fi/WLAN and high-efficiency wireless (HEW) communications. In accordance with some IEEE 802.11ax (High-Efficiency Wi-Fi (HEW)) embodiments, an master station 102 may operate as a master station which may be arranged to contend for a wireless medium (e.g., during a contention period) to receive exclusive control of the medium for an HEW control period (i.e., a transmission opportunity (TXOP)). The master station 102 may transmit an HEW master-sync transmission or trigger frame at the beginning of the HEW control period. The master station 102 may transmit a time duration of the TXOP. During the HEW control period, HEW devices 104 may communicate with the master station 102 in accordance with a non-contention based multiple access technique. This is unlike conventional WLAN communications in which devices communicate in accordance with a contention-based communication technique, rather than a multiple access technique. During the HEW control period, the master station 102 may communicate with HEW stations 104 using one or more HEW frames. During the HEW control period, legacy stations refrain from communicating. In some embodiments, the master-sync transmission may be referred to as an HEW control and schedule transmission.

In some embodiments, the multiple-access technique used during the HEW control period may be a scheduled orthogonal frequency division multiple access (OFDMA) technique, although this is not a requirement. In some embodiments, the multiple access technique may be a time-division multiple access (TDMA) technique or a frequency division multiple access (FDMA) technique. In some embodiments, the multiple access technique may be a space-division multiple access (SDMA) technique.

The master station 102 may also communicate with legacy stations 106 and/or HEW stations 104 in accordance with legacy IEEE 802.11 communication techniques. In some embodiments, the master station 102 may also be configurable to communicate with HEW stations 104 outside the HEW control period, which may be termed a transmission opportunity, in accordance with legacy IEEE 802.11 communication techniques, although this is not a requirement.

Some embodiments operate in accordance with OFDMA, where each STA may be allocated a portion of the channel bandwidth (unlike OFDM where each STA is allocated the entire channel bandwidth). The portion of the channel bandwidth is referred to as a sub-channel comprising of a set of OFDM sub-carriers. In some embodiments the portion of the channel may be referred to as a resource or resource allocation.

Preamble designs for IEEE 802.11ax are disclosed herein. In some embodiments, the preamble in IEEE 802.11ax may contain channel training symbols and the physical layer header called signal (SIG) field. Some embodiments disclosed herein may provide one or more of the following technical effects: early detection of which version of IEEE 802.11 the packet is such as IEEE 802.11ax, low overhead, and/or robustness in both indoor and outdoor channels.

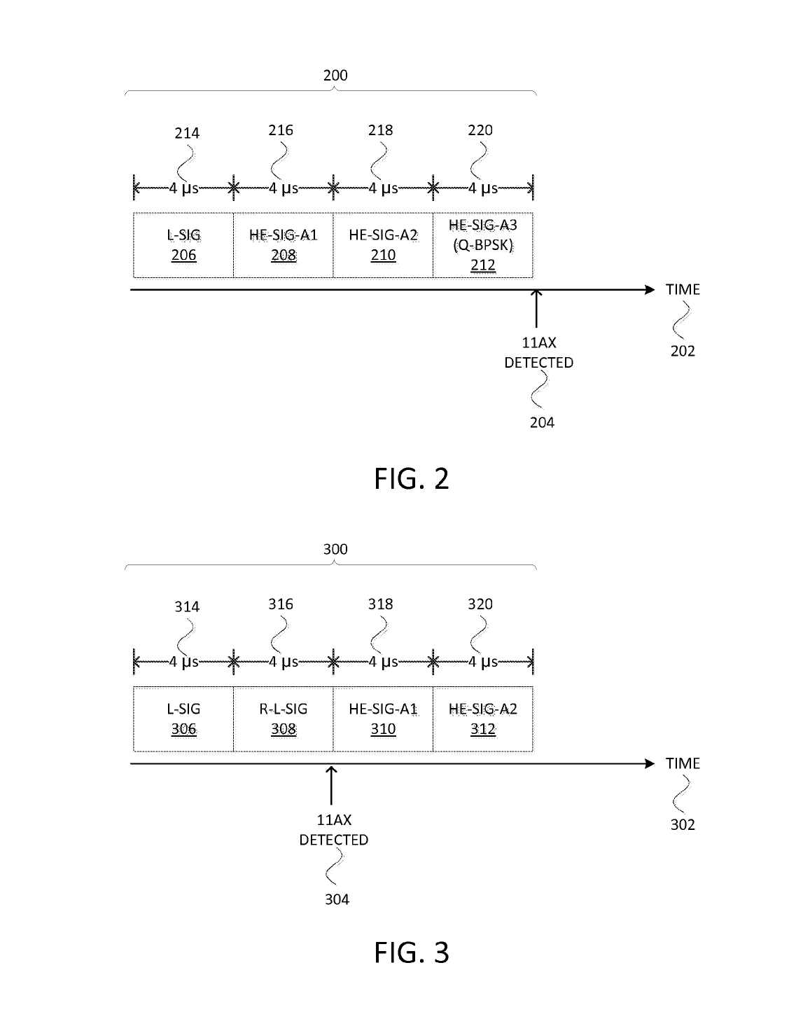

FIG. 2 illustrates a preamble 200 for IEEE 802.11ax in accordance with some embodiments. Illustrated in FIG. 2 is time 202 along a horizontal axis, a IEEE 802.11ax preamble 200, and 11ax detected 204. The IEEE 802.11ax preamble 200 may include a legacy signal (L-SIG) field 206, a HE-SIG A1 208 field, a HE-SIG-A2 210 field, and a HE-SIG-A3 212 field. Each of the fields 206, 208, 210, 212 may be 4 μs in duration. A receiving HEW station 104 will be able to detect the IEEE 802.11ax preamble 200 at time 11AX detected 204, which is 16 μs. The L-SIG 206 field may be a signal field in accordance with a legacy communication standard. The HE-SIG A1 208 field and HE-SIG-A2 210 field may be signal fields for HE. The HE-SIG-A3 212 field may be used in combination with other portions of the IEEE 802.11ax preamble 200 to indicate that the IEEE 802.11ax preamble 200 is for IEEE 802.11ax. The HE-SIG-A3 212 field may use a quadraphase binary phase shift keying (Q-BPSK) constellation to indicate that the preamble is an IEEE 802.11ax preamble 200. In some embodiments the Q-BPSK constellation may be rotated to indicate that the preamble is an IEEE 802.11ax preamble 200. The HE-SIG-A1 208 field may be a first symbol of a high efficiency signal field. The HE-SIG-A2 210 field may be a second symbol of a high efficiency signal field. The HE-SIG-A3 212 may be a third symbol of a high efficiency signal field. In outdoor use the IEEE 802.11ax preamble 200 may have a higher detection error rate of the HE-SIG-A3 212 field.

FIG. 3 illustrates a preamble 300 for IEEE 802.11ax in accordance with some embodiments. Illustrated in FIG. 3 is time 302 along a horizontal axis, a IEEE 802.11ax preamble 300, and 11ax detected 304. The IEEE 802.11ax preamble 200 may include a L-SIG field 306, a repeated L-SIG (R-L-SIG) 208 field, a HE-SIG-A1 310 field, and a HE-SIG-A2 312 field. Each of the fields 306, 308, 310, 312 may be 4 μs in duration. A receiving HEW station 104 will be able to detect the IEEE 802.11ax preamble 300 at time 11AX detected 304, which is 8 μs. The R-L-SIG 308 may be a repeated L-SIG 306 that is used to indicate that the preamble is an IEEE 802.11ax preamble 300. The HE-SIG-A1 310 field may be a first symbol of a high efficiency signal field. The HE-SIG-A2 310 field may be a second symbol of a high efficiency signal field. The R-L-SIG 308 may be less efficient since it may not provide signaling beyond the indication that the preamble is the IEEE 802.11ax preamble 300 in accordance with some embodiments.

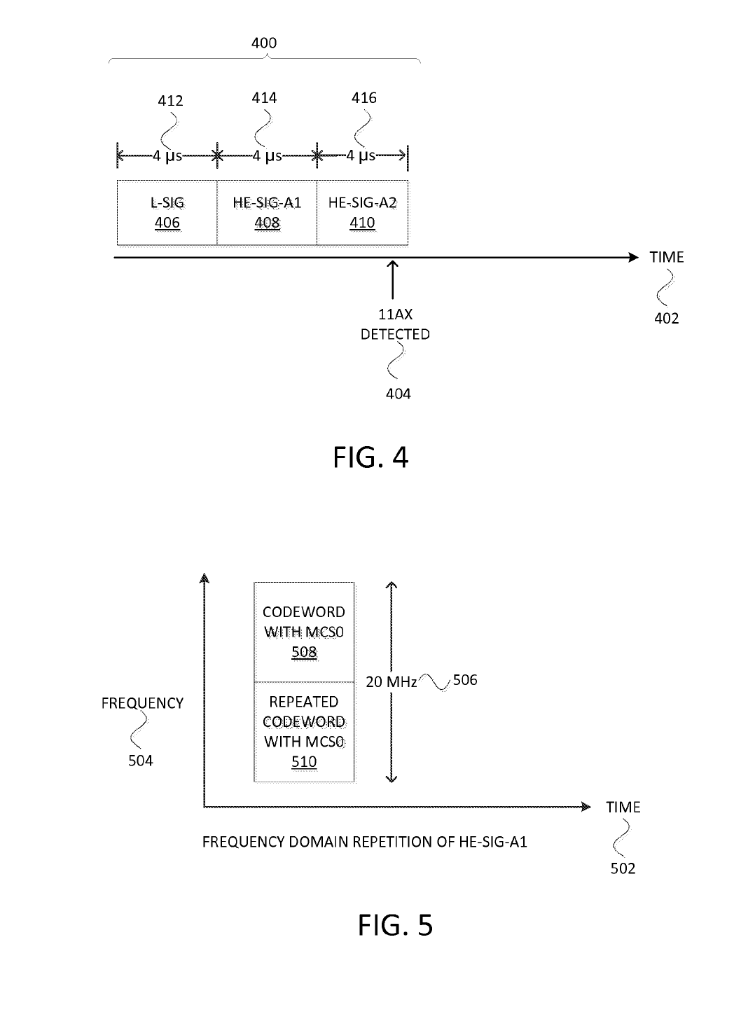

FIG. 4 illustrates a preamble 400 for IEEE 802.11ax in accordance with some embodiments. Illustrated in FIG. 4 is time 402 along a horizontal axis, an IEEE 802.11ax preamble 400, and 11ax detected 404. The IEEE 802.11ax preamble 400 may include L-SIG 406, HE-SIG-A1 408, and HE-SIG-A2 410. In some embodiments, the L-SIG 406, HE-SIG-A1 408, and/or HE-SIG-A2 410 may be 4 μs in duration. In some embodiments the L-SIG 406, HE-SIG-A1 408, and/or HE-SIG-A2 410 are a different duration.

HE-SIG-A1 408 may be individually encoded. Individually encoded may include where the information bits of the HE-SIG-A1 408 are not interleaved with other subfields. Individually encoded may include where the symbols or tones of the HE-SIG-A1 408 are not interleaved with other subfields. Individually encoded may include where a cyclic redundancy code (CRC) is generated for the HE-SIG-A1 408 and is included as part of the HE-SIG-A1 408 subfield. Individually encoded may include where the receiver of the HE-SIG-A1 408 can decode the HE-SIG-A1 408 subfield without using tones transmitted after the HE-SIG-A1 408. Individually encoded may include where receiver needs tones transmitted after the HE-SIG-A1 408 for a convolution code.

HE-SIG-A1 408 includes an indication that the IEEE 802.11ax preamble 400 is an IEEE 802.11ax preamble 400. A receiver may receive the IEEE 802.11ax preamble 400. The receiver may be a master station 102, HEW station 104, or legacy system 106. The legacy system 106 may not be able to decode the HE-SIG-A1 408 and will defer based on a length indicated in the L-SIG 406 portion of the IEEE 802.11ax preamble 400.

The receiver that receives the HE-SIG-A1 408 may decode the HE-SIG-A1 408 in less time since HE-SIG-A1 408 is individually encoded. For example, a HEW station 104 or master station 102 may be able to decode the HE-SIG-A1 408 at 11ax detected 404, which may be 3 μs after receiving HE-SIG-A1 408. In some embodiments, 11ax detected 404 may be earlier than 3 μs after receiving HE-SIG-A1 408 or later than 3 μs after receiving HE-SIG-A1. The receiver receiving the HE-SIG-A1 408 can determine that the IEEE 802.11ax preamble 400 is an IEEE 802.11ax preamble 400 after decoding HE-SIG-A1 408. The HEW station 104 may be able to decode the HE-SIG-A1 408 while still receiving HE-SIG-A2 410. Since the HEW station 104 and/or master station 102 is still receiving HE-SIG-A2 410 when the detection that it is an IEEE 802.11ax preamble 400 is made, the receiver does not have a problem such as missing the timing of IEEE 802.11n/ac automatic gain control (AGC) reset.

In some embodiments, the cyclic prefix (CP) of HE-SIG-A 408 (FIG. 4) symbols may be longer than the legacy 0.8 μs. This may enhance the robustness in outdoor channels. In some embodiments the CP of HE-SIG-A 408 symbols may be extended and/or the HE-SIG-A 408 may be repeated as described in conjunction with FIG. 5. A receiver may use one or both of the CP being longer and the repetition of the HE-SIG-A 408 as an indication that a preamble is an IEEE 802.11ax preamble 400. Simulation results described herein indicate that either making the CP longer or repeating the HE-SIG-A 408 is sufficient to reduce errors in outdoor use.

In some embodiments the length field of the L-SIG 406 may be used to signal either one of the CP duration is longer or the HE-SIG-A 408 is repeated or both. For example, the length field in L-SIG 408 may be used for signaling whether the repetition as described in conjunction with FIG. 5 is used. The value in the length field of the L-SIG 406 is a multiple of 3 in accordance with IEEE 802.11n/ac. The IEEE 802.11ax may use a value that is not a multiple of 3 e.g. 3k+1 to indicate no repetition and 3k+2 to indicate that the HE-SIG-A 408 is repeated, where k is an integer. If R-L-SIG 308 (FIG. 3) is used, the modulated information e.g. the polarization of R-L-SIG 308 in FIG. 3 can be used to signal the indication of whether the HE-SIG-A 408 is repeated. Similarly, the CP duration can be indicated by the length field of the L-SIG 406 or the modulated information in R-L-SIG 308. In some embodiments the duration of the CP and/or the repetition of the HE-SIG-A1 408 may be indicated in the payload of the first HE-SIG-A 408 symbol. After decoding the first HE-SIG-A1 408 symbol, the receiver may know the CP duration of each HE-SIG-A1 408 symbol such that the corresponding portions of the received samples may have a Fast Fourier Transform (FFT) operation applied to them.

In some embodiments, to increase the payload size, a tail biting convolutional code may be used to remove the tail bits. This may provide 12 additional information bits in HE-SIG-A1 408.

In some embodiments the HE-SIG-A1 408 may include a cyclic redundancy code (CRC) field that may provide the CRC for the HE-SIG-A1 408 or the HE-SIG-A1 408 and the L-SIG 406. For example, the receiver may need to perform a CRC check with 8 bits for the content of the HE-SIG-A1 408 or the content of the HE-SIG-A1 408 and the L-SIG 406.

The HE-SIG-A1 408 may include training signals on a 20 MHz band edges. This may increase the number of subcarriers for subsequent orthogonal frequency division multiplexing (OFDM). In some embodiments, the L-SIG 406 uses 52 subcarriers per 20 MHz. HE-SIG-A1 408 may use 56 subcarriers. The channel training signals are added for the four additional subcarriers, two on each edge of the 20 MHz band. Some coded symbols of L-SIG 406 may be sent on the additional subcarriers as channel training signals, which may enhance the reliability of the L-SIG 406 reception. The receiver can combine the signals in L-SIG 406 and those in the four additional subcarriers for decoding L-SIG 406. After successful decoding, the receiver also knows the transmitted signals on the four additional subcarriers such that the known, transmitted signals can be used as channel training signals for the additional four subcarriers.

FIG. 5 illustrates the frequency domain repetition of a HE-SIG-A1 in accordance with some embodiments. Illustrated in FIG. 5 is time 502 along the horizontal axis, frequency 504 along a vertical axis, codeword with modulation and coding scheme 0 (MCS0) 508, and repeated codeword with MCS0 510. The codeword may be the HE-SIG-A1 408 field (FIG. 4). The codeword may be encoded using MCS0 as described in conjunction with the IEEE 802.11 standard. A different encoding scheme may be used. As illustrated the codeword is transmitted twice in a 20 MHz subchannel 506 on different subcarriers. As illustrated the sub-carriers are contiguous, but in some embodiments the subcarriers may not be contiguous. The receiver may use the repeated codeword with MCS0 510 as an indication that a preamble is an IEEE 802.11ax preamble 400. In some embodiments the codeword with MCS0 508 may be transmitted in an entire sub-channel and the repeated codeword with MCS0 510 may be transmitted in a different entire sub-channel. For example, codeword with MCS0 508 may be transmitted within a 20 MHz primary sub-channel and repeated codeword with MCS0 510 may be transmitted in a different 20 MHz sub-channel.

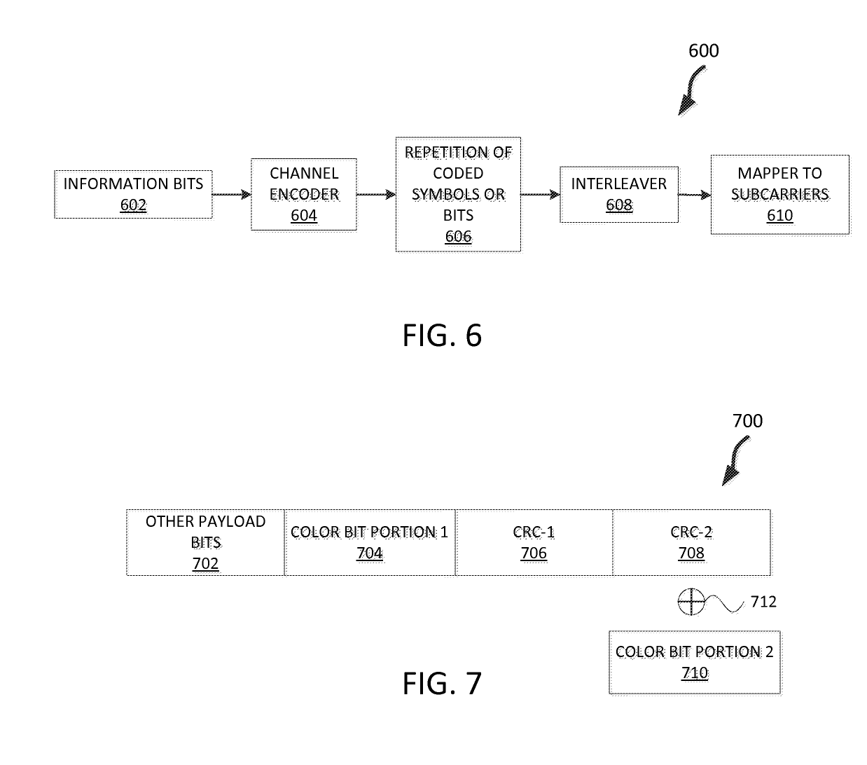

FIG. 6 illustrates a transmitter method 600 for repeating the HE-SIG-A1 in accordance with some embodiments. Illustrated in FIG. 6 are information bits 602, channel encoder 604, repetition of coded symbols or bits 606, interleaver 608, and mapper to subcarriers 610. The information bits 602 may be the bits for the HE-SIG-A1 408. The channel encoder 604 may encode for a sub-channel. The repetition of coded symbols or bits 606 may repeat the information bits 602 of the HE-SIG-A1 408 one or more times. The interleaver 608 may interleave the bits of the information bits 602 of both the HE-SIG-A1 408 and the one or more repetitions of the HE-SIG-A1 408. The mapper to subcarriers 610 may map the interleaved information bits to subcarriers of the sub-channel or sub-channels selected by the channel encoder 604.

FIG. 7 illustrates a packet 700 with a partially masked cyclic redundancy code in accordance with some embodiments. FIG. 7 illustrates other payload bits 702, color bit portion 1 704, CRC-1 706, CRC-2 708, color bit portion 2 710, and exclusive or 712. The packet 700 may be a preamble for IEEE 802.11ax. Other payload bits 702 may be other bits such as the L-SIG 406, HE-SIG-A1 408, and HE-SIG-A2 410 (see FIG. 4), as well as other fields that may be included in other payload bits 702. Color bit portion 1 704 and color bit portion 2 710 may be color bits that indicate a basic service set (BSS) identification. Color bit portion 1 704 and color bit portion 2 710 may be in accordance with IEEE 802.11ah. A complete color bit sequence may be 4-6 bit long.

The receiver may be attached to a BSS and may have color bits that identify the BSS 100 the receiver is attached to. A CRC code may be determined for the other payload bits 702 and color bit portion 1 704. The CRC may be divided into two portions CRC-1 706 and CRC-2 708.

CRC-2 708 may be masked with the color bit portion 2 710. The masking may be an exclusive-or operation performed bitwise on CRC-2 708 and the corresponding bits of the color bit portion 2 710.

The overhead of the CRC-1 706, CRC-2 708, color bit portion 1 704, and color bit portion 2 710 may be reduced by masking CRC-2 708 with color bit portion 2 710. In some embodiments the CRC is masked by the entire color bit portion. CRC-1 706 and CRC-2 708 together may be 8-10 bits long. CRC-1 706 can be read or decoded by all receivers that are configured to operate in accordance with IEEE 802.11ax. The receiver will be able to detect that the packet is an IEEE 802.11ax packet.

Only receivers that are both IEEE 802.11ax receivers and that have the color bits that match the color bit portion 1 704 and color bit portion 2 710 will be able to decode the entire packet and determine that the CRC sequence is correct. Other receives with a different color bits will determine that the CRC sequence indicates the packet 700 contains errors and will know that the packet 700 is an IEEE 802.11ax packet and may exit the reception early with the channel reservation parameters set properly so that power consumption may be reduced or the receiver may perform other operations such as receiving other and decoding other packets.

Masking the CRC may be applied to other parts of the IEEE 802.11ax packet 700 where CRC is used for verification. For example, HE-SIG-A2 410 and HE-SIG-B (not illustrated) and the data portion (not illustrated) of the packet 700 may have a CRC for verification. A HEW station or user identification (ID) or its shortened version e.g. association ID (AID), group ID, or partial group ID BSS ID (BSSID), or color bits can be used to mask the CRC. The HEW station 104 and/or master station 102 is configured to use the correct portion of the packet 700 to unmask with its corresponding information such as the AID of the HEW station 104 with the packet 700. If the CRC code fails, then the HEW station 104 and/or master station 102 stop decoding the packet 700 and may defer. If the CRC succeeds, then the HEW station 104 and/or master station 102 assume the packet 700 is indented for the HEW station 104 and/or master station 102.

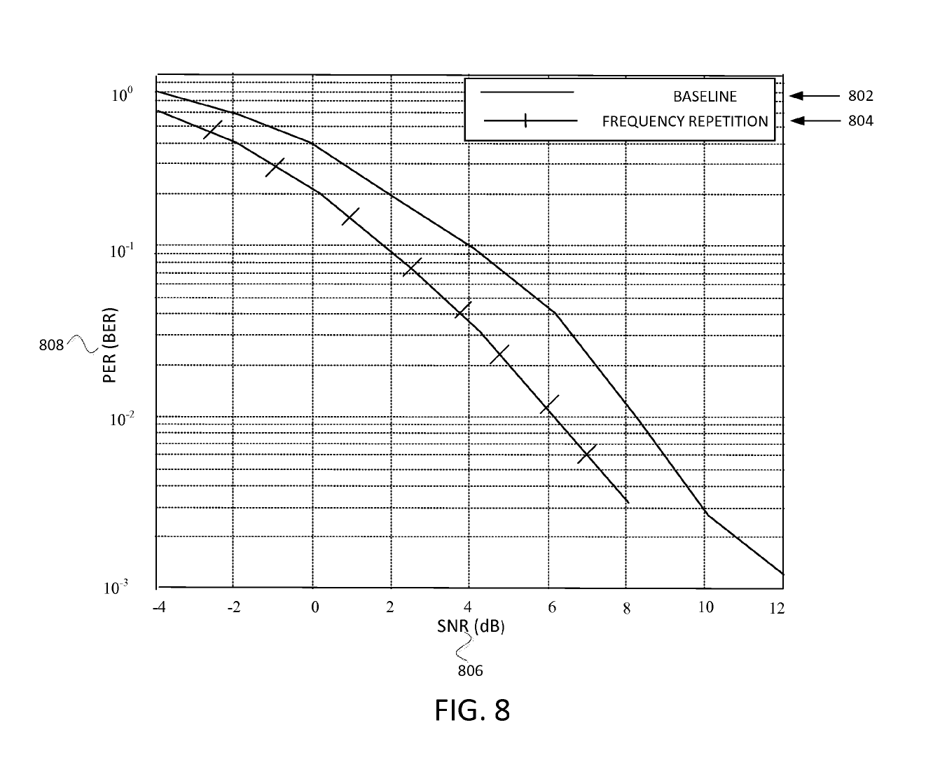

FIG. 8 illustrates the packet error rates (PERs) for a baseline 802 and frequency repetition 804 in accordance with some embodiments. Illustrated in FIG. 8 are signal to noise ratio (SNR) 806 in decibels (dB) along the horizontal axis, PERs 808 along the vertical axis, baseline 802, and frequency repetition 804. The baseline 802 is a channel model D with non-line of sight settings with 18 bit payload excluding tail bits. The frequency repetition 804 has a 12 bit payload and uses tail biting and frequency domain repetition and an MCS10, where MCS10 is in accordance with IEEE 802.11 standards.

The decoding delay is set for 3 μs for frequency repetition 804. 8 bits are used among the 12 bit payload for CRC signals for frequency repetition 804. The frequency repetition 804 has a better performance than the baseline 802 with about half the PERs. An 8 bit CRC provides a false alarm below about 0.4%. The 4 additional bits of the 12 payload bits (8 are for CRC) provide for reliable IEEE 802.11ax detection. The receiver of the frequency repetition 804 could lower the miss detection rate for IEEE 802.11ax and the false alarm rate for legacy packets such as IEEE 802.11 a/n/ac by checking the repetition of the preamble sent in the frequency repetition 804 and if there is a repetition then it is not a IEEE 802.11 a/n/ac packet. FIG. 8 illustrates that a IEEE 802.11ax preamble with frequency repetition and tail biting in accordance with some embodiments provides a robust method for detecting IEEE 802.11ax packets.

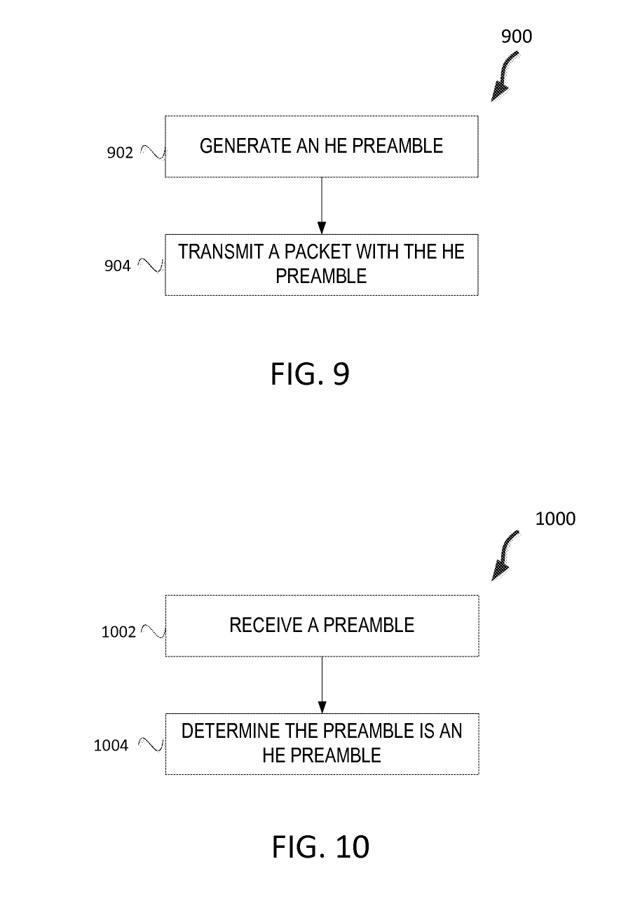

FIG. 9 illustrates a method 900 for transmitting a packet with an IEEE 802.11ax preamble in accordance with some embodiments. The method 900 begins at operation 902 with generate an HE preamble. For example a transmitter such as a master station 102 or HEW station 104 may generate the IEEE 802.11ax preamble 400. The HE preamble may be generated with a CRC field. For example, the CRC field may be masked with color bits as described in conjunction with FIG. 7. The IEEE 802.11ax preamble 400 may include an indication of whether or not frequency repetition is used, whether or not additional subcarriers are used, whether or not extended CP is used, whether or not tail biting is used, and whether or not a CRC is masked. The indication may be indicated by a size of the L-SIG 406 field that is not a multiple of three. For example, k+1 or k+2 with k an integer for the length field of the L-SIG 406 field may indicate one or more of whether or not frequency repetition is used, whether or not additional subcarriers are used, whether or not extended CP is used, whether or not tail biting is used, and/or whether or not a CRC is masked.

The method 900 continues at operation 904 with transmit a packet with the HE preamble. For example, the transmitter may transmit an IEEE 802.11ax packet (not illustrated) with the IEEE 802.11ax preamble 400. The transmitter may use frequency repetition as described in conjunction with FIG. 5. The transmitter may use extra subcarriers as described in conjunction with FIG. 4 to transmit the L-SIG 406 and/or the HE-SIG-A1 408 as well as other portions of the IEEE 802.11ax preamble 400. The transmitter may use an extended CP of one or more of the HE-SIG symbols as described in conjunction with FIG. 4.

FIG. 10 illustrates a method 1000 for determining a packet is an IEEE 802.11ax packet in accordance with some embodiments. The method 1000 begins at operation 1002 with receive a preamble. For example, a receiver such as a master station 102 or a HEW station 104 may receive the IEEE 802.11ax preamble 400. The IEEE 802.11ax preamble may be received with one or more of the following: frequency repetition, additional subcarriers, extended CP, tail biting, a CRC, and/or a masked CRC. The receiver may use the length of the L-SIG 406 to receive the HE preamble. For example, the length of the L-SIG 406 may indicate one or more of frequency repetition, additional subcarriers, extended CP, tail biting, a CRC, and/or a masked CRC as described in conjunction with FIG. 9 and herein. The receiver may combine the signals if the HE preamble is transmitted using frequency repetition.

The method 1000 continues at operation 1004 with determine the preamble is an HE preamble. For example, a receiver may determine that IEEE 802.11ax preamble 400 is an HE preamble at 11ax detected 404 based on the HE-SIG-A1 408. The receiver may use one or more of frequency repetition, additional subcarriers, extended CP, tail biting, a CRC, and/or a masked CRC to further determine the preamble is the HE preamble. For example if frequency repetition is used then this is an indication that the preamble is an HE preamble. The receiver may mask a CRC with the color bits of the receiver for the receiver's BSS to determine whether or not the HE preamble is for the receiver or not.

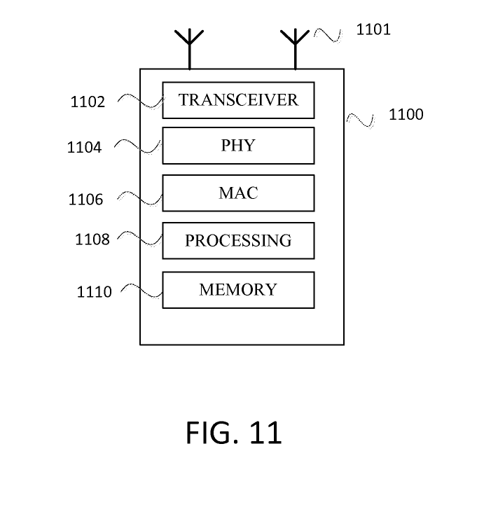

FIG. 11 illustrates a HEW device in accordance with some embodiments. HEW device 1100 may be an HEW compliant device that may be arranged to communicate with one or more other HEW devices, such as HEW STAs 104 (FIG. 1) or master station 102 (FIG. 1) as well as communicate with legacy devices 106 (FIG. 1). HEW STAs 104 and legacy devices 106 may also be referred to as HEW devices and legacy STAs, respectively. HEW device 1100 may be suitable for operating as master station 102 (FIG. 1) or a HEW STA 104 (FIG. 1). In accordance with embodiments, HEW device 1100 may include, among other things, a transmit/receive element 1101 (for example an antenna), a transceiver 1102, PHY circuitry 1104, and MAC circuitry 1106. PHY circuitry 1104 and MAC circuitry 1106 may be HEW compliant layers and may also be compliant with one or more legacy IEEE 802.11 standards. MAC circuitry 1106 may be arranged to configure PPDUs and arranged to transmit and receive PPDUs, among other things. HEW device 1100 may also include circuitry 1108 and memory 1110 configured to perform the various operations described herein. The circuitry 1108 may be coupled to the transceiver 1102, which may be coupled to the transmit/receive element 1101. While FIG. 11 depicts the circuitry 1108 and the transceiver 1102 as separate components, the circuitry 1108 and the transceiver 1102 may be integrated together in an electronic package or chip.

In some embodiments, the MAC circuitry 1106 may be arranged to contend for a wireless medium during a contention period to receive control of the medium for the HEW control period and configure an HEW PPDU. In some embodiments, the MAC circuitry 1106 may be arranged to contend for the wireless medium based on channel contention settings, a transmitting power level, and a CCA level.

The PHY circuitry 1104 may be arranged to transmit the HEW PPDU. The PHY circuitry 1104 may include circuitry for modulation/demodulation, upconversion/downconversion, filtering, amplification, etc. In some embodiments, the circuitry 1108 may include one or more processors. The circuitry 1108 may be configured to perform functions based on instructions being stored in a RAM or ROM, or based on special purpose circuitry. In some embodiments, the circuitry 1108 may be configured to perform one or more of the functions and/or methods described herein and/or in conjunction with FIGS. 1-11.

In some embodiments, the transmit/receive elements 1101 may be two or more antennas that may be coupled to the PHY circuitry 1104 and arranged for sending and receiving signals including transmission of the HEW packets. The transceiver 1102 may transmit and receive data such as HEW PPDU and packets that include an indication that the HEW device 1100 should adapt the channel contention settings according to settings included in the packet. The memory 1110 may store information for configuring the other circuitry to perform operations for configuring and transmitting HEW packets and performing the various operations to perform one or more of the functions and/or methods described herein and/or in conjunction with FIGS. 1-11.

In some embodiments, the HEW device 1100 may be configured to communicate using OFDM communication signals over a multicarrier communication channel. In some embodiments, HEW device 1100 may be configured to communicate in accordance with one or more specific communication standards, such as the Institute of Electrical and Electronics Engineers (IEEE) standards including IEEE 802.11-2012, 802.11n-2009, 802.11ac-2013, 802.11ax, DensiFi, standards and/or proposed specifications for WLANs, or other standards as described in conjunction with FIG. 1, although the scope of the invention is not limited in this respect as they may also be suitable to transmit and/or receive communications in accordance with other techniques and standards. In some embodiments, the HEW device 1100 may use 4x symbol duration of 802.11n or 802.11ac.

In some embodiments, an HEW device 1100 may be part of a portable wireless communication device, such as a personal digital assistant (PDA), a laptop or portable computer with wireless communication capability, a web tablet, a wireless telephone, a smartphone, a wireless headset, a pager, an instant messaging device, a digital camera, an access point, a television, a medical device (e.g., a heart rate monitor, a blood pressure monitor, etc.), an access point, a base station, a transmit/receive device for a wireless standard such as 802.11 or 802.16, or other device that may receive and/or transmit information wirelessly. In some embodiments, the mobile device may include one or more of a keyboard, a display, a non-volatile memory port, multiple antennas, a graphics processor, an application processor, speakers, and other mobile device elements. The display may be an LCD screen including a touch screen.

The transmit/receive element 1101 may comprise one or more directional or omnidirectional antennas, including, for example, dipole antennas, monopole antennas, patch antennas, loop antennas, microstrip antennas or other types of antennas suitable for transmission of RF signals. In some multiple-input multiple-output (MIMO) embodiments, the antennas may be effectively separated to take advantage of spatial diversity and the different channel characteristics that may result.

Although the HEW device 1100 is illustrated as having several separate functional elements, one or more of the functional elements may be combined and may be implemented by combinations of software-configured elements, such as processing elements including digital signal processors (DSPs), and/or other hardware elements. For example, some elements may comprise one or more microprocessors, DSPs, field-programmable gate arrays (FPGAs), application specific integrated circuits (ASICs), radio-frequency integrated circuits (RFICs) and combinations of various hardware and logic circuitry for performing at least the functions described herein. In some embodiments, the functional elements may refer to one or more processes operating on one or more processing elements.

The following examples pertain to further embodiments. Example 1 is an apparatus of a high-efficiency (HE) wireless local area network (HEW) station, the apparatus including circuitry configured to: generate a HE preamble comprising a legacy signal (L-SIG) field followed by a HE-SIG-A1 field, wherein the HE-SIG-A1 field is encoded individually; and transmit a packet that comprises the HE preamble.

In Example 2, the subject matter of Example 1 can optionally include where the circuitry is further configured to: transmit a code word of the HE preamble and a repetition of the code word within at least one from the following group: a sub-channel and two sub-channels.

In Example 3, the subject matter of Examples 1 and 2 can optionally include where the HE-SIG-A1 field is encoded by individual subcarriers that are not interleaved with subcarriers of other fields.

In Example 4, the subject matter of any of Examples 1-3 can optionally include where the circuitry is further configured to transmit the HE preamble with a cyclic prefix (CP) of the HE-SIG-A field that is longer than 0.8 micro-seconds (μs).

In Example 5, the subject matter of any of Examples 1-4 can optionally include where the circuitry is further configured to: indicate enhanced robustness of the packet in at least one of the ways from the following group: a length field of the L-SIG field, a polarization of a repeated L-SIG, and a field of the HE-SIG-A.

In Example 6, the subject matter of Example 5 can optionally include where the enhanced robustness is one from the following group: the HE preamble is to be transmitted with a cyclic prefix (CP) of the HE-SIG-A field that is longer than 0.8 micro-seconds (μs) and the HE preamble is to be transmitted on multiple sub-channels.

In Example 7, the subject matter of any of Examples 1-6 can optionally include where an end portion of the HE-SIG-A1 field for a convolution code unwinding is used to encode data.

In Example 8, the subject matter of any of Examples 1-7 can optionally include where the HE-SIG-A1 field comprises a cyclic redundancy code (CRC) field for one from the following group: the HE-SIG-A1 field; and, the L-SIG field combined with the HE-SIG-A1 field.

In Example 9, the subject matter of Example 8 can optionally include where the CRC field is masked with a color bit pattern, wherein the color bit pattern indicates a basic service set identification for a receiver of the packet.

In Example 10, the subject matter of Example 9 can optionally include where the CRC field is partially masked with the color bit pattern, and wherein the color bit pattern is 4-6 bits long and the CRC field is 8-10 bits long.

In Example 11, the subject matter of any of Examples 1-10 can optionally include where the circuitry is further configured to: transmit the HE-SIG-A1 field of the HE preamble with greater than 52 subcarriers for at least one 20 mega Hertz (MHz) sub-channel.

In Example 12, the subject matter of Example 11 can optionally include where the circuitry is further configured to: transmit the L-SIG field of the HE preamble on the greater than 52 subcarriers that the HE-SIG-A1 field is to be transmitted on, wherein the greater than 52 subcarriers are for training signals for a receiver to receive the HE-SIG-A1 field.

In Example 13, the subject matter of any of Examples 1-12 can optionally include where the packet further comprises a cyclic redundancy code field that is masked with one from the following group: an identification of a receiver of the packet, a color bit pattern, and base service set identification.

In Example 14, the subject matter of any of Examples 1-13 can optionally include where the HEW station is one from the following group: a HEW station, a master station, and an Institute of Electrical and Electronic Engineers (IEEE) access point.

In Example 15, the subject matter of any of Examples 1-14 can optionally include where the circuitry is further configured to: generate the HE preamble comprising a HE-SIG-A2 field.

In Example 16, the subject matter of any of Examples 1-15 can optionally include memory coupled to the circuitry; and one or more antennas coupled to the circuitry.

Example 17 is a method performed on a high-efficiency (HE) wireless local area network (HEW) station, the method comprising: generating a HE preamble comprising a legacy signal (L-SIG) field followed by a HE-SIG-A1 field, wherein the HE-SIG-A1 field is encoded individually; and transmitting a packet that comprises the HE preamble.

In Example 18, the subject matter of Example 17 can optionally include indicating enhanced robustness of the packet in at least one of the ways from the following group: a length field of the L-SIG field, a polarization of a repeated L-SIG, and a field of the HE-SIG-A.

In Example 19, the subject matter of Example 18 can optionally include where the enhanced robustness is one from the following group: the HE preamble is to be transmitted with a cyclic prefix (CP) of the HE-SIG-A field that is longer than 0.8 micro-seconds (μs) and the HE preamble is to be transmitted on multiple sub-channels.

Example 20 is an apparatus of a high-efficiency (HE) wireless local area network (HEW) station, including circuitry configured to: receive a packet comprising a HE preamble comprising a legacy signal (L-SIG) field followed by a HE-SIG-A1 field, wherein the HE-SIG-A1 field is encoded individually; decode the HE-SIG-A1 field; and determine the packet is a HE packet based on the HE-SIG-A1 field.

In Example 21, the subject matter of Example 20 can optionally include where the circuitry is further configured to: determine whether the packet indicates enhanced robustness in at least one way from the following group: a length field of the L-SIG field, a polarization of a repeated L-SIG, and a field of the HE-SIG-A, and wherein the enhanced robustness is one from the following group: the HE preamble has a cyclic prefix (CP) that is longer than 0.8 micro-seconds (μs) and the HE preamble is received on multiple sub-channels.

In Example 22, the subject matter of Examples 20 and 21 can optionally include where the HE-SIG-A1 is between 11 and 19 bits of information.

In Example 23, the subject matter of any of Examples 20-22 can optionally include memory coupled to the circuitry; and one or more antennas coupled to the circuitry.

Example 24 is a non-transitory computer-readable storage medium that stores instructions for execution by one or more processors of a high-efficiency (HE) wireless local-area network (WLAN) (HEW) master station, the operations to configure the one or more processors to cause the HEW master station to: generate a HE preamble comprising a legacy signal (L-SIG) field followed by a HE-SIG-A1 field, wherein the HE-SIG-A1 field is encoded individually; and transmit a packet that comprises the HE preamble.

In Example 25, the subject matter of Example 24 can optionally include where the operations are further to configure the one or more processors to cause the HEW master station to: indicate enhanced robustness of the packet in at least one of the ways from the following group: a length field of the L-SIG field, a polarization of a repeated L-SIG, and a field of the HE-SIG-A, and wherein the enhanced robustness is one from the following group: the HE preamble is to be transmitted with a cyclic prefix (CP) of the HE-SIG-A field that is longer than 0.8 micro-seconds (μs) and the HE preamble is to be transmitted on multiple sub-channels.

The Abstract is provided to comply with 37 C.F.R. Section 1.72(b) requiring an abstract that will allow the reader to ascertain the nature and gist of the technical disclosure. It is submitted with the understanding that it will not be used to limit or interpret the scope or meaning of the claims. The following claims are hereby incorporated into the detailed description, with each claim standing on its own as a separate embodiment.

1. An apparatus of a high-efficiency (HE) station, the apparatus comprising circuitry configured to:
generate a HE preamble comprising a legacy signal (L-SIG) field followed by a HE-SIG-A1 field, wherein the HE-SIG-A1 field is encoded individually; and
transmit a packet that comprises the HE preamble.

2. The apparatus of the HE station of claim 1, wherein the circuitry is further configured to:
transmit a code word of the HE preamble and a repetition of the code word within at least one from the following group: a sub-channel and two sub-channels.

3. The apparatus of the HE station of claim 1, wherein the HE-SIG-A1 field is encoded by individual subcarriers that are not interleaved with subcarriers of other fields.

4. The apparatus of the HE station of claim 1, wherein the circuitry is further configured to transmit the HE preamble with a cyclic prefix (CP) of the HE-SIG-A field that is longer than 0.8 micro-seconds (μs).

5. The apparatus of the HE station of claim 1, wherein the circuitry is further configured to:
indicate enhanced robustness of the packet in at least one of the ways from the following group: a length field of the L-SIG field, a polarization of a repeated L-SIG, and a field of the HE-SIG-A.

6. The apparatus of the HE station of claim 5, wherein the enhanced robustness is one from the following group: the HE preamble is to be transmitted with a cyclic prefix (CP) of the HE-SIG-A field that is longer than 0.8 micro-seconds (μs) and the HE preamble is to be transmitted on multiple sub-channels.

7. The apparatus of the HE station of claim 1, wherein an end portion of the HE-SIG-A1 field for a convolution code unwinding is used to encode data.

8. The apparatus of the HE station of claim 1, wherein the HE-SIG-A1 field comprises a cyclic redundancy code (CRC) field for one from the following group: the HE-SIG-A1 field; and, the L-SIG field combined with the HE-SIG-A1 field.

9. The apparatus of the HE station of claim 8, wherein the CRC field is masked with a color bit pattern, wherein the color bit pattern indicates a basic service set identification for a receiver of the packet.

10. The apparatus of the HE station of claim 9, wherein the CRC field is partially masked with the color bit pattern, and wherein the color hit pattern is 4-6 bits long and the CRC field is 8-10 bits long.

11. The apparatus of the HE station of claim 1, wherein the circuitry is further configured to:
transmit the HE-SIG-A1 field of the HE preamble with greater than 52 subcarriers for at least one 20 mega Hertz (MHz) sub-channel.

12. The apparatus of the HE station of claim 11, wherein the circuitry is further configured to:
transmit the L-SIG field of the HE preamble on the greater than 52 subcarriers that the HE-SIG-A1 field is to be transmitted on, wherein the greater than 52 subcarriers are for training signals for a receiver to receive the HE-SIG-A1 field.

13. The apparatus of the HE station of claim 1, wherein the packet further comprises a cyclic redundancy code field that is masked with one from the following group: an identification of a receiver of the packet, a color bit pattern, and base service set identification.

14. The apparatus of the HE station of claim 1, wherein the HE station is one from the following group: a HE station, a master station, and an Institute of Electrical and Electronic Engineers (IEEE) access point.

15. The apparatus of the HE station of claim 1, wherein the circuitry is further configured to:
generate the HE preamble comprising a HE-SIG-A2 field.

16. The apparatus of the HE station of claim 1, further comprising memory coupled to the circuitry; and one or more antennas coupled to the circuitry.

17. A method performed on a high-efficiency (HE) station, the method comprising:
generating a HE preamble comprising a legacy signal (L-SIG) field followed by a HE-SIG-A1 field, wherein the HE-SIG-A1 field is encoded individually; and
transmitting a packet that comprises the HE preamble.

18. The method of claim 17, further comprising:
indicating enhanced robustness of the packet in at least one of the ways from the following group: a length field of the L-SIG field, a polarization of a repeated L-SIG, and a field of the HE-SIG-A.

19. The method of claim 18, wherein the enhanced robustness is one from the following group: the HE preamble is to be transmitted with a cyclic prefix (CP) of the HE-SIG-A field that is longer than 0.8 micro-seconds (μs) and the HE preamble is to be transmitted on multiple sub-channels.

20. An apparatus of a high-efficiency (HE) station, comprising circuitry configured to:
receive a packet comprising a HE preamble comprising a legacy signal (L-SIG) field followed by a HE-SIG-A1 field, wherein the HE-SIG-A1 field is encoded individually;
decode the HE-SKI-A1 field; and
determine the packet is a HE packet based on the HE-SIG-A1 field.

21. The apparatus of the HE station of claim 20, wherein the circuitry is further configured to:
determine whether the packet indicates enhanced robustness in at least one way from the following group: a length field of the L-SIG field, a polarization of a repeated L-SIG, and a field of the HE-SIG-A, and wherein the enhanced robustness is one from the following group: the HE preamble has a cyclic prefix (CP) that is longer than 0.8 micro-seconds (μs) and the HE preamble is received on multiple sub-channels.

22. The apparatus of the HE station of claim 20, wherein the HE-SIG-A1 is between 11 and 19 bits of information.

23. The apparatus of the HE station of claim 20, further comprising memory coupled to the circuitry; and one or more antennas coupled to the circuitry.

24. A non-transitory computer-readable storage medium that stores instructions for execution by one or more processors of a high-efficiency (HE) master station, the operations to configure the one or more processors to cause the HE master station to:
generate a HE preamble comprising a legacy signal (L-SIG) field followed by a HE-SIG-A1 field, wherein the HE-SIG-A1 field is encoded individually; and
transmit a packet that comprises the HE preamble.

25. The non-transitory computer-readable storage medium of claim 24, wherein the operations are further to configure the one or more processors to cause the HE master station to:
indicate enhanced robustness of the packet in at least one of the ways from the following group: a length field of the L-SIG field, a polarization of a repeated L-SIG, and a field of the HE-SIG-A; and wherein the enhanced robustness is one from the following group: the HE preamble is to be transmitted with a cyclic prefix (CP) of the HE-SIG-A field that is longer than 0.8 micro-seconds (μs) and the HE preamble is to be transmitted on multiple sub-channels.
